(19) United States
(12) Patent Application Publication
(10) Pub. No.: US 2025/0141832 A1
(43) Pub. Date: May 1, 2025

(54) ADAPTIVE NETWORK ADDRESS TRANSLATION (NAT) METHOD AND APPARATUS FOR VOICE OVER INTERNET PROTOCOL (VOIP)

(71) Applicant: YEALINK (XIAMEN) NETWORK TECHNOLOGY CO., LTD., Xiamen (CN)

(72) Inventor: Yanzhang Lin, Xiamen (CN)

(21) Appl. No.: 18/932,652

(22) Filed: Oct. 31, 2024

(30) Foreign Application Priority Data
Oct. 31, 2023 (CN) 202311432533.2

(51) Int. Cl. H04L 61/2575; H04L 61/5014

(52) U.S. Cl. CPC H04L 61/2575; H04L 61/5014

(57) ABSTRACT

Provided are an adaptive network address translation (NAT) method and apparatus for VoIP. The NAT method includes: obtaining a first public network address of a STUN server, and connecting to the STUN server through a first port; obtaining a second public network address and a second port based on a connection status with the STUN server, where the second public network address and the second port are generated by the STUN server or a registration server; and initiating registration with the registration server based on the second public network address and the second port, whereby a public network address and a port of a phone in the registration server are respectively updated to the second public network address and the second port, and then a call center establishes a connection to the phone through the second public network address and the second port.

### CROSS REFERENCE TO RELATED APPLICATIONS

The present application claims the benefit of Chinese Patent Application No. 2023114325332 filed on Oct. 31, 2023, the contents of which are incorporated herein by reference in their entirety.

### TECHNICAL FIELD

The present disclosure relates to the communication field, and in particular, to an adaptive network address translation (NAT) method and apparatus for Voice over Internet Protocol (VOIP).

### BACKGROUND

Voice over Internet Protocol (VOIP) uses the Internet Protocol (IP) to transmit voice on an IP network in a form of a data packet. Network address translation (NAT), as a technology that converts a private address into a legitimate IP address, is widely used in various types of Internet access methods and various types of networks. The Transmission Control Protocol (TCP) is a connection-oriented, reliable, and byte stream-based transport layer communication protocol defined by RFC 793 of the Internet Engineering Task Force (IETF).

In a VOIP environment, if a phone uses the TCP for transmission, the TCP can ensure integrity and accuracy of voice data, ensure that the voice data is received in a sending order, and control a data sending rate to avoid network congestion and ensure transmission quality of the voice data. However, if the phone uses the TCP for transmission, and a server that cooperates with the phone often separates registration and call/subscription services, it is likely that a call center cannot call the phone through a public network website because a Contact header field of Session Initiation Protocol (SIP) signaling carries a private network address during registration of the phone.

### SUMMARY

The present disclosure provides an adaptive NAT method and apparatus for VOIP to solve a problem that a call center cannot call a phone through a public network website due to a low penetration success rate of automatically switching the phone in a VOIP environment.

To solve the above problem, the present disclosure provides an adaptive NAT method for VOIP, applicable to a phone, where the NAT method includes:
obtaining a first public network address of a Session Traversal Utilities for NAT (STUN) server, and connecting to the STUN server through a first port;
obtaining a second public network address and a second port based on a connection status with the STUN server, where the second public network address and the second port are generated by the STUN server or a registration server through mapping based on the first public network address and the first port; and
initiating registration with the registration server based on the second public network address and the second port, whereby a public network address and a port of the phone in the registration server are respectively updated to the second public network address and the second port, and then a call center establishes a connection to the phone through the second public network address and the second port.

The present disclosure first obtains the first public network address, connects the phone to the STUN server through the first port, and then obtains, from the STUN server or the registration server based on the connection status, the second public network address and the second port that are generated through the mapping based on the first public network address and the first port. The STUN server itself provides communication support for the phone. Therefore, the STUN server can quickly and efficiently authenticate the first public network address and the first port of the phone, and then obtains the second public network address and the second port through the mapping. Moreover, the registration server plays a same role as the STUN server, and achieves a more significant speed and convenience compared with a commonly used SIP-based public network address registration method. Therefore, adopting different methods to obtain the second public network address and the second port for different connection statuses can accelerate progress of NAT. Finally, the phone uses the second public network address and the second port to initiate the registration with the registration server, whereby the public network address and the port of the phone can be unified and updated, enabling the call center to successfully connect to the phone through the second public network address and the second port. Compared with the prior art, the present disclosure deploys the STUN server and the adaptive NAT method to improve a penetration success rate of automatically switching the phone, so as to solve a problem that the call center cannot call the phone through a public network website.

As a preferred solution, the second public network address and the second port are generated by the STUN server or a registration server through mapping based on the first public network address and the first port is specifically as follows:
initiating, if determining that the connection status indicates a successful connection, a network binding request to the STUN server, whereby the STUN server outputs a mapped address and port of the phone in a public network based on the first public network address and the first port, and obtaining the second public network address and the second port through a router; or
initiating, if determining that the connection status indicates a failed connection, the registration with the registration server by an rport field, and obtaining the second public network address and the second port that are mapped by the registration server based on the first public network address and the first port.

In this preferred solution, the successful connection indicates that the STUN server supports the TCP. Therefore, a TCP link can be continuously used to obtain the public network address and the port from the STUN server. That is, the phone initiates the network binding request to the STUN server to obtain the second public network address and the second port. The second public network address and the second port are the public network address and the port (the first public network address and the first port) that are used by the phone at this time. After obtaining this information, the STUN server returns, through the router, the second public network address and the second port that are obtained by the STUN server through the mapping. This preferred solution obtains the public network address and the port of the phone by the STUN server connected to the phone. The STUN server itself provides the communication support for the phone. Therefore, in this method, the public network address and the port (the first public network address and the first port) that are used by the phone can be quickly authenticated by the STUN server, thereby obtaining the second public network address and the second port through the mapping. This greatly reduces time required to obtain the second public network address and the second port.

As a preferred solution, the initiating, if determining that the connection status indicates a failed connection, the registration with the registration server by an rport field, and obtaining the second public network address and the second port that are mapped by the registration server based on the first public network address and the first port is specifically as follows:
if determining that the connection status indicates the failed connection, initiating SIP registration with the registration server by the rport field, and making a Via header field of the registration server carry the rport field, whereby the registration server outputs the second public network address and the second port that are obtained through the mapping based on the first public network address and the first port, where the second public network address and the second port are output by the registration server by carrying a parameter related to the rport field in a success status response code.

This preferred solution is for the failed connection. The failed connection indicates that the STUN server does not support the TCP. Therefore, the TCP link cannot be continuously used to obtain the public network address and the port from the STUN server. Instead, the SIP registration with the registration server is initiated by the rport field. In this way, when the registration server receives a request message for the SIP registration, the registration server verifies a “sent by” parameter in the Via header field. If a host part of the “sent by” parameter is different from an actual address of the request message, the registration server modifies a value of the parameter to the actual address of the request message, namely the first public network address. Moreover, the rport field is carried in the Via header field of the registration server, whereby an actual port, namely the first port, can be carried in the request message for the SIP registration. Finally, the registration server outputs the second public network address and the second port that are obtained through the mapping based on the first public network address and the first port. This preferred solution obtains the public network address and the port of the phone through the registration server. As the STUN server does not support the TCP, the rport method is used to initiate the registration with the registration server. At this time, the registration server plays a role of the STUN server when the connection is successful. Compared with the commonly used SIP-based public network address registration method, the method of obtaining the second public network address and the second port through the registration server greatly reduces operation complexity, and effectively improves its target obtaining speed.

As a preferred solution, the obtaining a second public network address and a second port based on a connection status with the STUN server further includes:
if determining that the connection status indicates a successful connection, binding the STUN server and the second port by sending a TCP STUN Bind request to the STUN server, and binding the STUN server and the second port again by sending TCP SIP signaling to the STUN server.

This preferred solution binds the STUN server and the second port by creating a parent-child process. Because the phone uses the second port to perform mapping with the STUN server through the router, the phone must also use the second port when interacting with the STUN server through the router. Therefore, the parent-child process is used to bind the second port for a plurality of times. In this way, the router considers that a same port is mapped, and the STUN server can then find the phone in an internal network through the mapped port and address.

As a preferred solution, the initiating registration with the registration server based on the second public network address and the second port, whereby a public network address and a port of the phone in the registration server are respectively updated to the second public network address and the second port is specifically as follows:
initiating SIP registration with the registration server by the second public network address as a Contact header field of SIP registration signaling and the second port as a port of the SIP registration signaling, whereby the public network address and the port of the phone in the registration server are respectively updated to the second public network address and the second port.

This preferred solution uses the second public network address and the second port to initiate the registration with the registration server. In this way, the public network address and the port of the phone in the registration server can be updated, whereby the second public network address and the second port of the phone are authenticated by a registration center and the call center. This ensures that the call center can successfully connect to the phone through the second public network address and the second port when a communication connection is subsequently performed.

As a preferred solution, the obtaining a first public network address of a STUN server is specifically as follows:
setting a DHCP OPTION field in the STUN server, and using a router to obtain the first public network address of the STUN server.

In this preferred solution, the DHCP OPTION field of the STUN server is often used to store control information and parameters that are not defined in an ordinary protocol. Therefore, when the public network address of the phone is requested, required configuration information can be obtained by setting the DHCP OPTION field. This method achieves a high information obtaining speed and convenience, and can accelerate the progress of the NAT.

The present disclosure further provides an adaptive network address switching method for VOIP, which is applicable to a registration server. The network address switching method includes:
receiving a registration request initiated by a phone, where the registration request is initiated by the phone based on a third public network address and a third port; the third public network address and the third port are generated by the phone by mapping a fourth public network address and a fourth port based on a connection status between the phone and a STUN server; and the phone obtains the fourth public network address of the STUN server by setting a field, and establishes a connection to the STUN server through the fourth port; and
respectively updating a public network address and a port of the phone to the third public network address and the third port based on the registration request, whereby a call center establishes a connection to the phone through the third public network address and the third port.

As a preferred solution, the third public network address and the third port are generated by the phone by mapping a fourth public network address and a fourth port based on a connection status between the phone and a STUN server is specifically as follows:
enabling, if determining that the connection status between the phone and the STUN server indicates a successful connection, the phone to initiate a network binding request to the STUN server, whereby the STUN server outputs a mapped address and port of the phone in a public network based on the fourth public network address and the fourth port, and obtaining the third public network address and the third port through a router; or
obtaining, if determining that the connection status between the phone and the STUN server indicates a failed connection, the registration request initiated by the phone by an rport field, and obtaining the third public network address and the third port through the mapping based on the fourth public network address and the fourth port.

As a preferred solution, the obtaining, if determining that the connection status between the phone and the STUN server indicates a failed connection, the registration request initiated by the phone by an rport field, and obtaining the third public network address and the third port through the mapping based on the fourth public network address and the fourth port is specifically as follows:
if determining that the connection status between the phone and the STUN server indicates the failed connection, obtaining a SIP registration request initiated by the phone by the rport field, making a Via header field carry the rport field, and outputting the third public network address and the third port that are obtained through the mapping based on the fourth public network address and the fourth port, where the third public network address and the third port are output by carrying a parameter related to the rport field in a success status response code.

As a preferred solution, the third public network address and the third port are generated by the phone by mapping a fourth public network address and a fourth port based on a connection status between the phone and a STUN server further includes:
if determining that the connection status between the phone and the STUN server indicates a successful connection, binding the STUN server and the third port by enabling the phone to send a TCP STUN Bind request to the STUN server; and
binding the STUN server and the third port again by enabling the phone to send TCP SIP signaling to the STUN server.

As a preferred solution, the receiving a registration request initiated by a phone is specifically as follows:
receiving a SIP registration request initiated by the phone based on the third public network address and the third port, where the SIP registration request is constituted by the third public network address as a Contact header field of SIP registration signaling and the third port as a port of the SIP registration signaling.

As a preferred solution, the phone obtains the fourth public network address of the STUN server by setting a field is specifically as follows:
setting, by the phone, a DHCP OPTION field in the STUN server, and using a router to obtain the fourth public network address of the STUN server.

The present disclosure further provides an adaptive NAT apparatus for VOIP, which is applicable to a phone. The NAT apparatus includes: a first preprocessing module, an information obtaining module, and a first registration module, where
the first preprocessing module is configured to obtain a first public network address of a STUN server, and connect to the STUN server through a first port;
the information obtaining module is configured to obtain a second public network address and a second port based on a connection status with the STUN server, where the second public network address and the second port are generated by the STUN server or a registration server through mapping based on the first public network address and the first port; and
the first registration module is configured to initiate registration with the registration server based on the second public network address and the second port, whereby a public network address and a port of the phone in the registration server are respectively updated to the second public network address and the second port, and then a call center establishes a connection to the phone through the second public network address and the second port.

As a preferred solution, the second public network address and the second port are generated by the STUN server or a registration server through mapping based on the first public network address and the first port is specifically as follows:
initiating, if determining that the connection status indicates a successful connection, a network binding request to the STUN server, whereby the STUN server outputs a mapped address and port of the phone in a public network based on the first public network address and the first port, and obtaining the second public network address and the second port through a router; or
initiating, if determining that the connection status indicates a failed connection, the registration with the registration server by an rport field, and obtaining the second public network address and the second port that are mapped by the registration server based on the first public network address and the first port.

As a preferred solution, the initiating, if determining that the connection status indicates a failed connection, the registration with the registration server by an rport field, and obtaining the second public network address and the second port that are mapped by the registration server based on the first public network address and the first port is specifically as follows:
if determining that the connection status indicates the failed connection, initiating SIP registration with the registration server by the rport field, and making a Via header field of the registration server carry the rport field, whereby the registration server outputs the second public network address and the second port that are obtained through the mapping based on the first public network address and the first port, where the second public network address and the second port are output by the registration server by carrying a parameter related to the rport field in a success status response code.

As a preferred solution, the obtaining a second public network address and a second port based on a connection status with the STUN server further includes:
if determining that the connection status indicates a successful connection, binding the STUN server and the second port by sending a TCP STUN Bind request to the STUN server, and binding the STUN server and the second port again by sending TCP SIP signaling to the STUN server.

As a preferred solution, the initiating registration with the registration server based on the second public network address and the second port, whereby a public network address and a port of the phone in the registration server are respectively updated to the second public network address and the second port is specifically as follows:
initiating SIP registration with the registration server by the second public network address as a Contact header field of SIP registration signaling and the second port as a port of the SIP registration signaling, whereby the public network address and the port of the phone in the registration server are respectively updated to the second public network address and the second port.

As a preferred solution, the obtaining a first public network address of a STUN server is specifically as follows:
setting a DHCP OPTION field in the STUN server, and using a router to obtain the first public network address of the STUN server.

The present disclosure further provides an adaptive network address switching apparatus for VOIP, which is applicable to a registration server. The network address switching apparatus includes a signal receiving module and a second registration module, where
the signal receiving module is configured to receive a registration request initiated by a phone, where the registration request is initiated by the phone based on a third public network address and a third port; the third public network address and the third port are generated by the phone by mapping a fourth public network address and a fourth port based on a connection status between the phone and a STUN server; and the phone obtains the fourth public network address of the STUN server by setting a field, and establishes a connection to the STUN server through the fourth port; and
the second registration module is configured to respectively update a public network address and a port of the phone to the third public network address and the third port based on the registration request, whereby a call center establishes a connection to the phone through the third public network address and the third port.

As a preferred solution, the third public network address and the third port are generated by the phone by mapping a fourth public network address and a fourth port based on a connection status between the phone and a STUN server is specifically as follows:
enabling, if determining that the connection status between the phone and the STUN server indicates a successful connection, the phone to initiate a network binding request to the STUN server, whereby the STUN server outputs a mapped address and port of the phone in a public network based on the fourth public network address and the fourth port, and obtaining the third public network address and the third port through a router; or
obtaining, if determining that the connection status between the phone and the STUN server indicates a failed connection, the registration request initiated by the phone by an rport field, and obtaining the third public network address and the third port through the mapping based on the fourth public network address and the fourth port.

As a preferred solution, the obtaining, if determining that the connection status between the phone and the STUN server indicates a failed connection, the registration request initiated by the phone by an rport field, and obtaining the third public network address and the third port through the mapping based on the fourth public network address and the fourth port is specifically as follows:
if determining that the connection status between the phone and the STUN server indicates the failed connection, obtaining a SIP registration request initiated by the phone by the rport field, making a Via header field carry the rport field, and outputting the third public network address and the third port that are obtained through the mapping based on the fourth public network address and the fourth port, where the third public network address and the third port are output by carrying a parameter related to the rport field in a success status response code.

As a preferred solution, the third public network address and the third port are generated by the phone by mapping a fourth public network address and a fourth port based on a connection status between the phone and a STUN server further includes:
if determining that the connection status between the phone and the STUN server indicates a successful connection, binding the STUN server and the third port by enabling the phone to send a TCP STUN Bind request to the STUN server; and
binding the STUN server and the third port again by enabling the phone to send TCP SIP signaling to the STUN server.

As a preferred solution, the receiving a registration request initiated by a phone is specifically as follows:
receiving a SIP registration request initiated by the phone based on the third public network address and the third port, where the SIP registration request is constituted by the third public network address as a Contact header field of SIP registration signaling and the third port as a port of the SIP registration signaling.

As a preferred solution, the phone obtains the fourth public network address of the STUN server by setting a field is specifically as follows:
setting, by the phone, a DHCP OPTION field in the STUN server, and using a router to obtain the fourth public network address of the STUN server.

The present disclosure further provides an adaptive NAT system for VOIP, including a NAT apparatus and a network address switching apparatus, where
the NAT apparatus is configured to execute the above adaptive NAT method for VOIP; and
the network address switching apparatus is configured to execute the above adaptive network address switching method for VoIP.

### BRIEF DESCRIPTION OF THE DRAWINGS

FIG. 1 is a schematic flowchart of an adaptive NAT method for VOIP according to an embodiment of the present disclosure;

FIG. 2 is a penetration diagram of a TCP STUN method according to an embodiment of the present disclosure;

FIG. 3 is a penetration diagram of an Rport method according to an embodiment of the present disclosure;

FIG. 4 is a schematic flowchart of an adaptive network address switching method for VOIP according to an embodiment of the present disclosure;

FIG. 5 is a schematic structural diagram of an adaptive NAT apparatus for VOIP according to an embodiment of the present disclosure;

FIG. 6 is a schematic structural diagram of a network address switching apparatus for VOIP according to an embodiment of the present disclosure; and

FIG. 7 is a schematic structural diagram of a NAT system for VOIP according to an embodiment of the present disclosure.

### DETAILED DESCRIPTION

The technical solutions in the embodiments of the present disclosure are clearly and completely described below with reference to the drawings in the embodiments of the present disclosure. Apparently, the described embodiments are only some rather than all of the embodiments of the present disclosure. All other embodiments obtained by a person of ordinary skill in the art based on the embodiments of the present disclosure without creative efforts shall fall within the protection scope of the present disclosure.

In the description of the present disclosure, it should be understood that terms such as “first”, “second”, “third”, and “fourth” are used merely for a descriptive purpose, and should not be construed as indicating or implying a relative importance, or implicitly indicating a quantity of indicated technical features. Therefore, features defined by the terms “first”, “second”, “third”, and “fourth” may explicitly or implicitly include one or more of the features. In the description of the present disclosure, unless otherwise specified, “a plurality of” means two or more.

### Embodiment 1

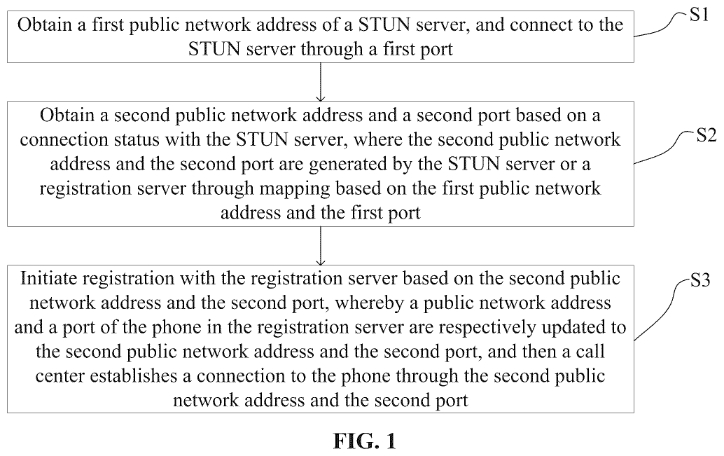

Referring to FIG. 1, an adaptive NAT method for VOIP provided in this embodiment of the present disclosure includes steps S1 to S3:

S1: Obtain a first public network address of a STUN server, and connect to the STUN server through a first port.

In this embodiment, the S1 includes substeps S1.1 and S1.2:

S1.1: A phone uses a router to obtain the first public network address of the STUN server by setting a DHCP OPTION field in the STUN server.

TABLE 1
DHCP OPTION field list provided in this embodiment

| | Code | | Len | | contents | | | | | | | |
|---|---|---|---|---|---|---|---|---|---|---|---|---|
| + | ----- | + | ----- | + | ----- | + | ----- | + | ----- | + | ----- | + |
| \| | 1 | \| | 4 | \| | m1 | \| | m2 | \| | m3 | \| | m4 | \| |
| + | ----- | + | ----- | + | ----- | + | ----- | + | ----- | + | ----- | + |

To apply this embodiment of the present disclosure, reference is made to Table 1. Table 1 is the DHCP OPTION field list provided in this embodiment. Herein, a custom Code field is 122, and a Len field is 4. For example, when the first public network address of the STUN server is 188.188.188.188, after the DHCP OPTION field is set, it can be obtained that fields in the above field list are 122 4 188 188 188 188, and it can be obtained that the first public network address is 188.188.188.188.

It should be noted that an internal network (Lan port) is connected to the phone, while an external network (Wan port) is connected to an external device (various servers). The router plays a role similar to an intermediary. The phone can connect to the server by connecting to the router. Therefore, the phone can finally obtain the first public network address of the STUN server through the router.

S1.2: The phone connects to the STUN server through the first port, Port A, where the Port A is assumed to be 5060.

S2: Obtain a second public network address and a second port based on a connection status with the STUN server, where the second public network address and the second port are generated by the STUN server or a registration server through mapping based on the first public network address and the first port.

In this embodiment, the S2 includes substeps S2.1 and S2.2:

S2.1: If determining that the connection status indicates a successful connection, the phone initiates a STUN BINDING request to the STUN server, whereby the STUN server outputs a mapped address and port of the phone in a public network based on a combination of the first public network address and the first port [188.188.188.188 and Port A (5060)], and the phone obtains the second public network address and the second port (188.188.188.186:5060) through the router.

If it is determined that the connection status indicates a failed connection, SIP registration with the registration server is initiated by an rport field, and a Via header field of the registration server is enabled to carry the rport field, whereby the registration server outputs the second public network address and the second port (188.188.188.186:5060) that are obtained through the mapping based on the combination of the first public network address and the first port [188.188.188.188 and Port A (5060)]. The second public network address and the second port are output by the registration server by carrying a parameter related to the rport field in a 200 OK response.

In this embodiment, firstly, it should be noted that the successful connection indicates that the STUN server supports the TCP. Therefore, a TCP link can be continuously used to obtain the public network address and the port from the STUN server. That is, the phone initiates the STUN BINDING request to the STUN server to obtain the second public network address and the second port. The second public network address and the second port are the public network address and the port (the first public network address and the first port) that are used by the phone at this time. After obtaining this information, the STUN server returns, through the router, the second public network address and the second port that are obtained by the STUN server through the mapping. That is, the phone sends the STUN BINDING request to the STUN server, whereby the STUN server knows which public network address and port are used by the phone at this time. Then, the STUN server returns the address and the port to the phone through a STUN RSP message. Moreover, the router maps the public network address and the port for the phone only after “the phone initiates the STUN BINDING request to the STUN server by the first public network address and the first port.” A direct combination of the first public network address and the first port is not supported by the router, and a result of the direct combination is meaningless. As a result, other servers cannot connect to an address obtained through the direct combination.

Secondly, it should be noted that the failed connection indicates that the STUN server does not support the TCP. Therefore, the TCP link cannot be continuously used to obtain the public network address and the port from the STUN server. Instead, the SIP registration with the registration server is initiated by the rport field. In this way, when the registration server receives a request message for the SIP registration, the registration server verifies a “sent by” parameter in the Via header field. If a host part of the “sent by” parameter is a domain name or an IP address but different from an actual address of the message packet (request message), the server must add a “received” parameter to the Via header field, and a value of the parameter must be the actual address (the first public network address) of the message packet. In a NAT environment, the host part of the “sent-by” parameter in the Via header field of the message received by the server is inevitably inconsistent with the actual address. In this case, the server adds the “received” parameter to the Via header field, and the terminal (phone) can understand an actual source address of the message packet based on this parameter.

Moreover, the rport field is carried in the Via header field of the registration server, whereby an actual port, namely the first port, can be carried in the request message for the SIP registration. Finally, the registration server outputs the second public network address and the second port that are obtained through the mapping based on the first public network address and the first port.

In this embodiment, for the successful connection, a public network address and a port of the phone are obtained by the STUN server connected to the phone. The STUN server itself provides communication support for the phone. Therefore, in this method, the public network address and the port (the first public network address and the first port) that are used by the phone can be quickly authenticated by the STUN server, thereby obtaining the second public network address and the second port through the mapping. This greatly reduces time required to obtain the second public network address and the second port.

In this embodiment, for the failed connection, the public network address and the port of the phone are obtained through the registration server. As the STUN server does not support the TCP, the rport method is used to initiate the registration with the registration server. At this time, the registration server plays a role of the STUN server when the connection is successful. Compared with a commonly used SIP-based public network address registration method, the method of obtaining the second public network address and the second port through the registration server greatly reduces operation complexity, and effectively improves its target obtaining speed.

The following is a process provided in this embodiment, in which the phone initiates the SIP registration with the registration server by the rport field when determining that the connection status indicates the failed connection:
REGISTER sip: ylas.yealink.com: 5060 SIP/2.0
Via: SIP/2.0/TCP;branch=z9hG4bK656629564;rport
From: “240014”<sip: 240014@ylas.yealink.com: 5060>;tag-656052336
To: “240014”<sip: 240014@ylas.yealink.com: 5060>
Call-ID: 0_656082031@2053:10:50:68:825e:cff:fe5c:c746
CSeq: 3 REGISTER
Contact: <sip: 240014@123.123.123.123: 5060>
Allow: INVITE, INFO, PRACK, ACK, BYE, CANCEL, OPTIONS, NOTIFY, REGISTER, SUBSCRIBE, REFER, PUBLISH, UPDATE, MESSAGE
Max-Forwards: 70
User-Agent: Yealink W70B 146.85.0.40 Expires: 3600
Allow-Events: talk, hold, conference, refer, check-sync
Content-Length: 0

The following is a process provided in this embodiment. In this process, after the phone initiates the SIP registration with the registration server by the rport field when determining that the connection status indicates the failed connection, the registration server carries the parameter related to the rport field in the 200 OK response to bring over the second public network address and the second port of the device:
SIP/2.0 200 OK
Via: SIP/2.0/UDP received=188.188.188.186;rport-5060;branch=z9hG4bKkjsh77
From: “240014”<sip: 240014@ylas.yealink.com: 5060>;tag-656052336
To: “240014”<sip: 240014@ylas.yealink.com: 5060>
Call-ID: 0_656082031@2053:10:50:68:825e:cff:fe5c:c746
CSeq: 3 REGISTER
Contact: <sip: 240014@188.188.188.186: 5060>
Allow: INVITE, INFO, PRACK, ACK, BYE, CANCEL, OPTIONS, NOTIFY, REGISTER, SUBSCRIBE, REFER, PUBLISH, UPDATE, MESSAGE
Max-Forwards: 70
User-Agent: Yealink W70B 146.85.0.40
Expires: 3600
Allow-Events: talk, hold, conference, refer, check-sync
Content-Length: 0

S2.2: If determining that the connection status indicates the successful connection, bind the STUN server and the second port by sending a TCP STUN Bind request to the STUN server and performing bind and listen operations by the second port Port A (5060), and bind the STUN server and the second port again by sending TCP SIP signaling to the STUN server and performing the bind and listen operations by the second port Port A (5060).

In this embodiment, the STUN server and the second port are bound by creating a parent-child process. Because the phone uses the second port to perform mapping with the STUN server through the router, the phone must also use the second port when interacting with the STUN server through the router. Therefore, the parent-child process is used to bind the second port for a plurality of times. In this way, the router considers that a same port is mapped, and the STUN server can then find the phone in the internal network through the mapped port and address, to ensure smooth data and information exchange.

S3: Initiate the registration with the registration server based on the second public network address and the second port, whereby the public network address and the port of the phone in the registration server are respectively updated to the second public network address and the second port, and then a call center establishes a connection to the phone through the second public network address and the second port.

In this embodiment, the S3 includes substeps S3.1 and S3.2:

S3.1: Initiate the SIP registration with the registration server by the second public network address (188.188.188.186) as a Contact header field of SIP registration signaling and the second port Port A (5060) as a port of the SIP registration signaling, whereby the public network address and the port of the phone in the registration server are respectively updated to the second public network address and the second port (188.188.188.186:5060).

The following is a process in which the phone initiates the registration with the registration server based on the second public network address and the second port:
REGISTER sip: ylas.yealink.com: 5060 SIP/2.0
Via: SIP/2.0/TCP 188.188.188.186:5060;branch=z9hG4bK656629564
From: “240014”<sip: 240014@ylas.yealink.com: 5060>;tag-656052336
To: “240014”<sip: 240014@ylas.yealink.com: 5060>
Call-ID: 0_656082031@2053:10:50:68:825e:cff:fe5c:c746
CSeq: 3 REGISTER
Contact: <sip: 240014@188.188.188.186: 5060>
Allow: INVITE, INFO, PRACK, ACK, BYE, CANCEL, OPTIONS, NOTIFY, REGISTER, SUBSCRIBE, REFER, PUBLISH, UPDATE, MESSAGE
Max-Forwards: 70
User-Agent: Yealink W70B 146.85.0.40
Expires: 3600
Allow-Events: talk, hold, conference, refer, check-sync
Content-Length: 0

This embodiment uses the second public network address and the second port to initiate the registration with the registration server. In this way, the public network address and the port of the phone in the registration server can be updated, whereby the second public network address and the second port of the phone are authenticated by a registration center and the call center. This ensures that the call center can successfully connect to the phone through the second public network address and the second port when a communication connection is subsequently performed.

S3.2: When the call center needs to send an INVITE message to the phone, the call center directly sends the INVITE message to the second public network address and the second port (188.188.188.186:5060) of the phone, whereby the router can successfully send the INVITE message to the phone in the internal network to establish a connection between the call center and the phone.

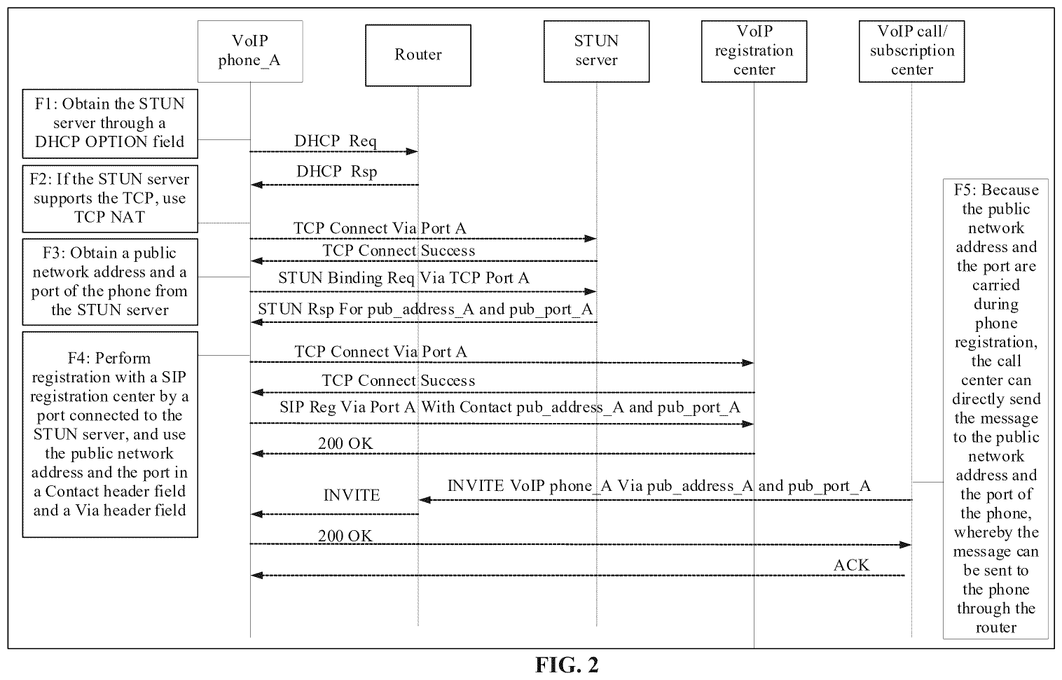

To apply this embodiment of the present disclosure, reference is made to FIG. 2. FIG. 2 is a penetration diagram of a TCP STUN method provided in this embodiment. A specific implementation is as follows:

F1: Obtain the STUN server through the DHCP OPTION field.

DHCP OPTION field: Herein, the Code field is customized to 122, and the Len field is customized to 4. For example, when a public network address of the STUN server is 188.188.188.188, it is obtained that the above fields are 122 4 188 188 188 188, and it can be obtained that the public network address of the STUN server is 188.188.188.188.

A VOIP phone sends a DHCP Req message to the router through a Port A (port), and the router returns the public network address (188.188.188.188) of the STUN server to the phone through a DHCP Rsq message.

F2: The VOIP phone sends a TCP Connect Via Port A message to the STUN server by the Port A that is assumed to be 5060, to connect to the STUN server. If the STUN server returns a TCP Connect Success message, the connection is successful, indicating that the STUN server supports the TCP and the TCP link can be continuously used to obtain a public network address from the server.

F3: The VOIP phone sends a STUN Binding Req Via TCP Port A message to the STUN server by the port A, to initiate a STUN BINDING request. The STUN server returns an address and a port of the phone in the public network (188.188.188.186:5060) through a STUN Rsp For pub_address_A and pub_port_A message.

F4: An internal service Fork of the VOIP phone creates a new process (using a parent-child process of a Linux mechanism for a plurality of bind operations), and the Port A (5060) is used to perform the bind and listen operations to bind the STUN server and the Port A (5060). Then, the VOIP phone initiates registration with the registration server through a SIP Reg Via Port A With Contact pub_address_A and pub_port_A message. A Contact header field and a port of the SIP registration signaling are the address and the port that are carried from the STUN server, namely 188.188.188.186:5060 in this embodiment.

If the registration server returns a 200 OK message to the VOIP phone, it indicates successful registration, and then the public network address of the phone in the registration center and the call center is updated.

F5: When the call center needs to send an INVITE message to the phone, the call center directly sends the INVITE message to the public network address 188.188.188.186:5060 of the phone, whereby the router can successfully send the INVITE message to the phone in the internal network.

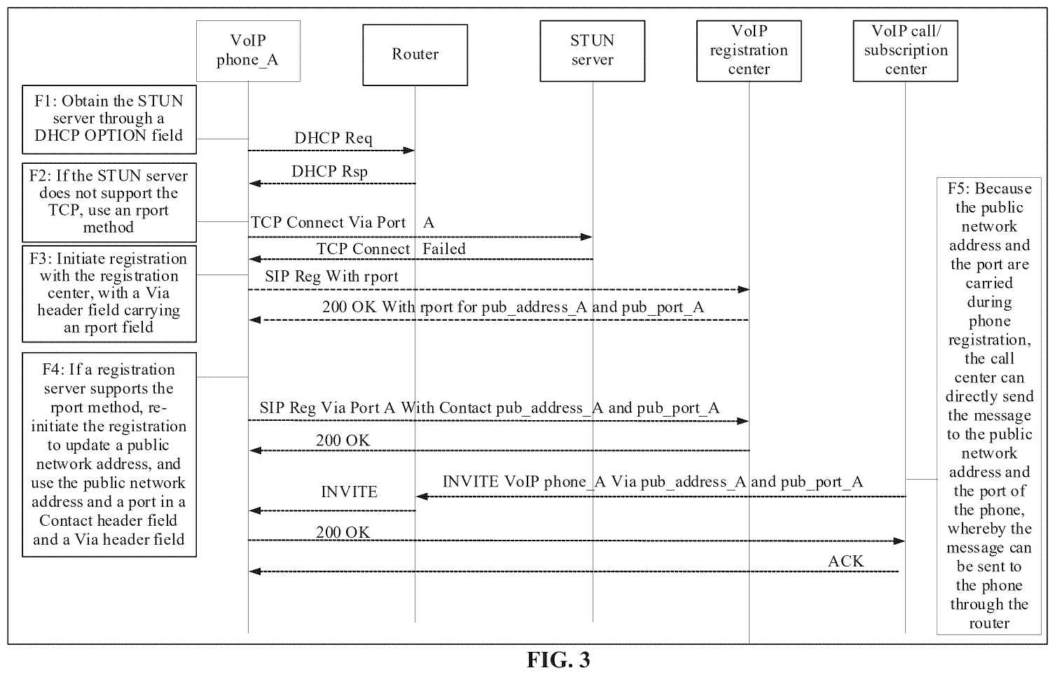

To apply this embodiment of the present disclosure, reference is made to FIG. 3. FIG. 3 is a penetration diagram of an Rport method provided in this embodiment. It should be noted that when the STUN server does not support the TCP, automatic switching to the Rport method is performed (the Rport method needs to be supported by the registration server). A specific implementation is as follows:

F1: Obtain the STUN server through the DHCP OPTION field.

DHCP OPTION field: Herein, the Code field is customized to 122, and the Len field is customized to 4. For example, when a public network address of the STUN server is 188.188.188.188, it is obtained that the above fields are 122 4 188 188 188 188 188, and it can be obtained that the public network address of the STUN server is 188.188.188.188.

A VOIP phone sends a DHCP Req message to the router through a Port A (port), and the router returns the public network address (188.188.188.188) of the STUN server to the phone through a DHCP Rsq message.

F2: The VOIP phone sends a TCP Connect Via Port A message to the STUN server by the Port A that is assumed to be 5060, to connect to the STUN server. If the STUN server returns a TCP Connect Failed message, the connection is failed, and the switching to the Rport method is performed.

F3: The VOIP phone uses the Rport method to send a SIP Reg With rport message to the registration server (VOIP registration center) to initiate SIP registration with the registration server and make a registered Via header field carry the rport field.

F4: If the registration server supports the Rport method, a public network address of the device is brought over through a 200 OK With rport for pub_address_A and pub_port_A message. That is, a parameter related to the rport field is carried in the 200 OK response to bring over the public network address of the device.

Then, the VOIP phone initiates registration with the registration server through a SIP Reg Via Port A With Contact pub_address_A and pub_port_A message. A Contact header field and a port of the SIP registration signaling are the address and the port that are carried from the STUN server, namely 188.188.188.186:5060 in this embodiment.

If the registration server returns a 200 OK message to the VOIP phone, it indicates successful registration, and then the public network address of the phone in the registration center and the call center is updated.

F5: When the call center needs to send an INVITE message to the phone, the call center directly sends the INVITE message to the public network address 188.188.188.186:5060 of the phone, whereby the router can successfully send the INVITE message to the phone in the internal network.

Generally, this embodiment has the following beneficial effects:

This embodiment first obtains the first public network address, connects the phone to the STUN server through the first port, and then obtains, from the STUN server or the registration server based on the connection status, the second public network address and the second port that are generated through the mapping based on the first public network address and the first port. The STUN server itself provides the communication support for the phone. Therefore, the STUN server can quickly and efficiently authenticate the first public network address and the first port of the phone, and then obtains the second public network address and the second port through the mapping. Moreover, the registration server plays a same role of the STUN server, and achieves more significant speed and convenience compared with the commonly used SIP-based public network address registration method. Therefore, adopting different methods to obtain the second public network address and the second port for different connection statuses can accelerate the progress of the NAT.

Moreover, when the connection status indicates the successful connection, the parent-child process is created to bind the STUN server and the second port to ensure that the STUN server can successfully find the phone in the network phone through the mapped port and address subsequently, thereby reducing a possibility of the failed connection. Finally, the phone uses the second public network address and the second port to initiate the registration with the registration server, whereby the public network address and the port of the phone can be unified and updated, enabling the call center to successfully connect to the phone through the second public network address and the second port.

### Embodiment 2

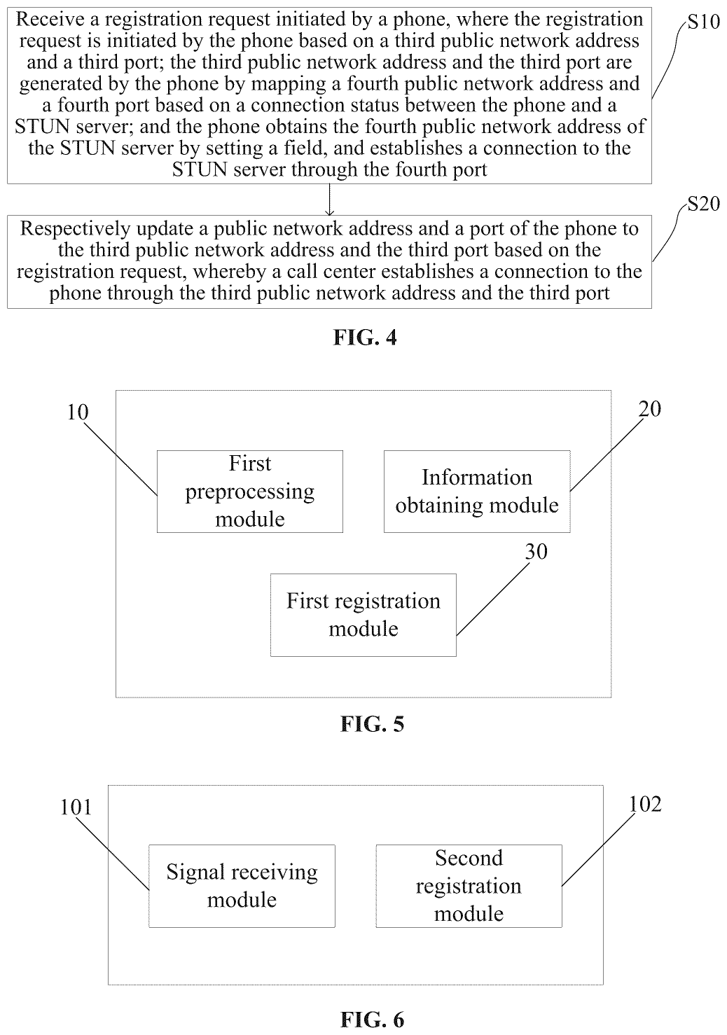

Referring to FIG. 4, an adaptive network address switching method for VOIP provided in this embodiment of the present disclosure includes steps S10 and S20:

S10: Receive a registration request initiated by a phone, where the registration request is initiated by the phone based on a third public network address and a third port; the third public network address and the third port are generated by the phone by mapping a fourth public network address and a fourth port based on a connection status between the phone and a STUN server; and the phone obtains the fourth public network address of the STUN server by setting a field, and establishes a connection to the STUN server through the fourth port.

In this embodiment, the S10 includes substeps S10.1 to S10.4:

S10.1: The phone sets a DHCP OPTION field in the STUN server and uses a router to obtain the fourth public network address of the STUN server; and establishes the connection to the STUN server through the fourth port.

S10.2: Enable, if determining that the connection status between the phone and the STUN server indicates a successful connection, the phone to initiate a network binding request to the STUN server, whereby the STUN server outputs a mapped address and port of the phone in a public network based on the fourth public network address and the fourth port, and obtain the third public network address and the third port through the router.

If it is determined that the connection status between the phone and the STUN server indicates a failed connection, the STUN server obtains a SIP registration request initiated by the phone by an rport field, carries the rport field in a Via header field. and outputs the third public network address and the third port that are obtained through combined mapping based on the fourth public network address and fourth port. The third public network address and the third port are output by carrying a parameter related to the rport field in a success status response code.

S10.3: If determining that the connection status between the phone and the STUN server indicates the successful connection, bind the STUN server and the third port by enabling the phone to send a TCP STUN Bind request to the STUN server.

The STUN server and the third port are bound again by enabling the phone to send TCP SIP signaling to the STUN server.

S10.4: Receive a SIP registration request initiated by the phone based on the third public network address and the third port, where the SIP registration request is constituted by the third public network address as a Contact header field of SIP registration signaling and the third port as a port of the SIP registration signaling.

S20: Respectively update a public network address and a port of the phone to the third public network address and the third port based on the registration request, whereby a call center establishes a connection to the phone through the third public network address and the third port.

Based on the description in Embodiment 1, a person skilled in the art can apply an adaptive NAT method for VOIP to the adaptive network address switching method for VOIP in this embodiment.

### Embodiment 3

Referring to FIG. 5, an adaptive NAT apparatus for VOIP provided in this embodiment of the present disclosure includes: a first preprocessing module 10, an information obtaining module 20, and a first registration module 30.

The first preprocessing module 10 is configured to obtain a first public network address of a STUN server, and connect to the STUN server through a first port.

The information obtaining module 20 is configured to obtain a second public network address and a second port based on a connection status with the STUN server. The second public network address and the second port are generated by the STUN server or a registration server through mapping based on the first public network address and the first port.

The first registration module 30 is configured to initiate registration with the registration server based on the second public network address and the second port, whereby a public network address and a port of a phone in the registration server are respectively updated to the second public network address and the second port, and then a call center establishes a connection to the phone through the second public network address and the second port.

In an embodiment, the second public network address and the second port are generated by the STUN server or a registration server through mapping based on the first public network address and the first port is specifically as follows:
initiating, if determining that the connection status indicates a successful connection, a network binding request to the STUN server, whereby the STUN server outputs a mapped address and port of the phone in a public network based on the first public network address and the first port, and obtaining the second public network address and the second port through a router; or
initiating, if determining that the connection status indicates a failed connection, the registration with the registration server by an rport field, and obtaining the second public network address and the second port that are mapped by the registration server based on the first public network address and the first port.

In an embodiment, the initiating, if determining that the connection status indicates a failed connection, the registration with the registration server by an rport field, and obtaining the second public network address and the second port that are mapped by the registration server based on the first public network address and the first port is specifically as follows:
if determining that the connection status indicates the failed connection, initiating SIP registration with the registration server by the rport field, and making a Via header field of the registration server carry the rport field, whereby the registration server outputs the second public network address and the second port that are obtained through the mapping based on the first public network address and the first port, where the second public network address and the second port are output by the registration server by carrying a parameter related to the rport field in a success status response code.

In an embodiment, the obtaining a second public network address and a second port based on a connection status with the STUN server further includes:
if determining that the connection status indicates the successful connection, binding the STUN server and the second port by sending a TCP STUN Bind request to the STUN server, and binding the STUN server and the second port again by sending TCP SIP signaling to the STUN server.

In an embodiment, the initiating registration with the registration server based on the second public network address and the second port, whereby a public network address and a port of the phone in the registration server are respectively updated to the second public network address and the second port is specifically as follows:
initiating the SIP registration with the registration server by the second public network address as a Contact header field of SIP registration signaling and the second port as a port of the SIP registration signaling, whereby the public network address and the port of the phone in the registration server are respectively updated to the second public network address and the second port.

In an embodiment, the obtaining a first public network address of a STUN server is specifically as follows:
setting a DHCP OPTION field in the STUN server, and using the router to obtain the first public network address of the STUN server.

The apparatus first obtains the first public network address, connects the phone to the STUN server through the first port, and then obtains, from the STUN server or the registration server based on the connection status, the second public network address and the second port that are generated through the mapping based on the first public network address and the first port. The STUN server itself provides communication support for the phone. Therefore, the STUN server can quickly and efficiently authenticate the first public network address and the first port of the phone, and then obtains the second public network address and the second port through the mapping. Moreover, the registration server plays a same role of the STUN server, and achieves more significant speed and convenience compared with a commonly used SIP-based public network address registration method. Therefore, adopting different methods to obtain the second public network address and the second port for different connection statuses can accelerate progress of NAT. Finally, the phone uses the second public network address and the second port to initiate the registration with the registration server, whereby the public network address and the port of the phone can be unified and updated, enabling the call center to successfully connect to the phone through the second public network address and the second port.

In another implementation example, the adaptive NAT apparatus for VOIP includes a processor. The processor is configured to execute the foregoing program modules stored in a memory, including the first preprocessing module 10, the information obtaining module 20, and the first registration module 30.

Referring to FIG. 6, an adaptive network address switching apparatus for VOIP provided in this embodiment of the present disclosure includes a signal receiving module 101 and a second registration module 102.

The signal receiving module 101 is configured to receive a registration request initiated by a phone. The registration request is initiated by the phone based on a third public network address and a third port. The third public network address and the third port are generated by the phone by mapping a fourth public network address and a fourth port based on a connection status between the phone and a STUN server. The phone obtains the fourth public network address of the STUN server by setting a field, and establishes a connection to the STUN server through the fourth port.

The second registration module 102 is configured to respectively update a public network address and a port of the phone to the third public network address and the third port based on the registration request, whereby a call center establishes a connection to the phone through the third public network address and the third port.

In an embodiment, the third public network address and the third port are generated by the phone by mapping a fourth public network address and a fourth port based on a connection status between the phone and a STUN server is specifically as follows:
enabling, if determining that the connection status between the phone and the STUN server indicates a successful connection, the phone to initiate a network binding request to the STUN server, whereby the STUN server outputs a mapped address and port of the phone in a public network based on the fourth public network address and the fourth port, and obtaining the third public network address and the third port through a router; or
obtaining, if determining that the connection status between the phone and the STUN server indicates a failed connection, the registration request initiated by the phone by an rport field, and obtaining the third public network address and third port through the mapping based on the fourth public network address and the fourth port.

In an embodiment, the obtaining, if determining that the connection status between the phone and the STUN server indicates a failed connection, the registration request initiated by the phone by an rport field, and obtaining the third public network address and the third port through the mapping based on the fourth public network address and the fourth port is specifically as follows:
if determining that the connection status between the phone and the STUN server indicates the failed connection, obtaining a SIP registration request initiated by the phone by the rport field, making a Via header field carry the rport field, and outputting the third public network address and the third port that are obtained through the mapping based on the fourth public network address and the fourth port, where the third public network address and the third port are output by carrying a parameter related to the rport field in a success status response code.

In an embodiment, the third public network address and the third port are generated by the phone by mapping a fourth public network address and a fourth port based on a connection status between the phone and a STUN server further includes:
if determining that the connection status between the phone and the STUN server indicates the successful connection, binding the STUN server and the third port by enabling the phone to send a TCP STUN Bind request to the STUN server; and
binding the STUN server and the third port again by enabling the phone to send TCP SIP signaling to the STUN server.

In an embodiment, the receiving a registration request initiated by a phone is specifically as follows:
receiving a SIP registration request initiated by the phone based on the third public network address and the third port, where the SIP registration request is constituted by the third public network address as a Contact header field of SIP registration signaling and the third port as a port of the SIP registration signaling.

In an embodiment, the phone obtains the fourth public network address of the STUN server by setting a field is specifically as follows:
setting, by the phone, a DHCP OPTION field in the STUN server, and using the router to obtain the fourth public network address of the STUN server.

In another implementation example, the adaptive network address switching apparatus for VOIP includes a processor. The processor is configured to execute the foregoing program modules stored in a memory, including the signal receiving module 101 and the second registration module 102.

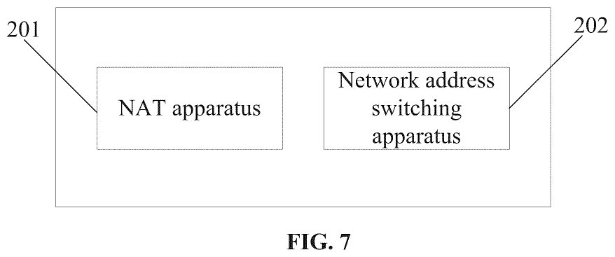

Referring to FIG. 7, an adaptive NAT system for VOIP provided in this embodiment of the present disclosure includes a NAT apparatus 201 and a network address switching apparatus 202.

The NAT apparatus 201 is configured to execute the foregoing adaptive NAT method for VOIP.

The network address switching apparatus 202 is configured to execute the above adaptive network address switching method for VoIP.

Correspondingly, the embodiments of the present disclosure further provide a computer-readable storage medium. The computer-readable storage medium includes a stored computer program. The computer program is run to control a device on which the computer-readable storage medium is located to execute the adaptive NAT method for VoIP and the adaptive network address switching method for VoIP.

If implemented in a form of a software functional unit and sold or used as a stand-alone product, the adaptive NAT method for VOIP and the adaptive network address switching method for VOIP may be stored in a computer-readable storage medium. Based on such an understanding, all or some of processes for implementing the methods in the foregoing embodiments can be completed by a computer program instructing relevant hardware. The computer program may be stored in a computer-readable storage medium. The computer program is executed by a processor to perform the steps of the foregoing method embodiments. The computer program includes computer program code, and the computer program code may be in a form of source code, object code, or an executable file, may be in some intermediate forms, or the like. The computer-readable medium may include: any physical entity or apparatus capable of carrying computer program code, a recording medium, a USB disk, a mobile hard disk drive, a magnetic disk, an optical disc, a computer memory, a read-only memory (ROM), a random access memory (RAM), an electrical carrier signal, a telecommunications signal, a software distribution medium, and the like.

The above descriptions are merely preferred implementations of the present disclosure. It should be noted that a person of ordinary skill in the art may further make several improvements and modifications without departing from the principle of the present disclosure, but such improvements and modifications should be deemed as falling within the protection scope of the present disclosure.

1. An adaptive network address translation (NAT) method for Voice over Internet Protocol (VOIP), applicable to a phone, wherein the NAT method comprises:
obtaining a first public network address of a Session Traversal Utilities for NAT (STUN) server, and connecting to the STUN server through a first port;
obtaining a second public network address and a second port based on a connection status with the STUN server, wherein the second public network address and the second port are generated by the STUN server or a registration server through mapping based on the first public network address and the first port; and
initiating registration with the registration server based on the second public network address and the second port, whereby a public network address and a port of the phone in the registration server are respectively updated to the second public network address and the second port, and then a call center establishes a connection to the phone through the second public network address and the second port.

2. The adaptive NAT method for VOIP according to claim 1, wherein the second public network address and the second port are generated by the STUN server or a registration server through mapping based on the first public network address and the first port is specifically as follows:
initiating, if determining that the connection status indicates a successful connection, a network binding request to the STUN server, whereby the STUN server outputs a mapped address and port of the phone in a public network based on the first public network address and the first port, and obtaining the second public network address and the second port through a router; or
initiating, if determining that the connection status indicates a failed connection, the registration with the registration server by an rport field, and obtaining the second public network address and the second port that are mapped by the registration server based on the first public network address and the first port.

3. The adaptive NAT method for VOIP according to claim 2, wherein the initiating, if determining that the connection status indicates a failed connection, the registration with the registration server by an rport field, and obtaining the second public network address and the second port that are mapped by the registration server based on the first public network address and the first port is specifically as follows:
if determining that the connection status indicates the failed connection, initiating Session Initiation Protocol (SIP) registration with the registration server by the rport field, and making a Via header field of the registration server carry the rport field, whereby the registration server outputs the second public network address and the second port that are obtained through the mapping based on the first public network address and the first port, wherein the second public network address and the second port are output by the registration server by carrying a parameter related to the rport field in a success status response code.

4. The adaptive NAT method for VOIP according to claim 1, wherein the obtaining a second public network address and a second port based on a connection status with the STUN server further comprises:
if determining that the connection status indicates a successful connection, binding the STUN server and the second port by sending a Transmission Control Protocol (TCP) STUN Bind request to the STUN server, and binding the STUN server and the second port again by sending TCP SIP signaling to the STUN server.

5. The adaptive NAT method for VOIP according to claim 1, wherein the initiating registration with the registration server based on the second public network address and the second port, whereby a public network address and a port of the phone in the registration server are respectively updated to the second public network address and the second port is specifically as follows:
initiating SIP registration with the registration server by the second public network address as a Contact header field of SIP registration signaling and the second port as a port of the SIP registration signaling, whereby the public network address and the port of the phone in the registration server are respectively updated to the second public network address and the second port.

6. The adaptive NAT method for VOIP according to claim 1, wherein the obtaining a first public network address of a STUN server is specifically as follows:
setting a Dynamic Host Configuration Protocol (DHCP) OPTION field in the STUN server, and using a router to obtain the first public network address of the STUN server.

7. An adaptive network address switching method for VOIP, applicable to a registration server, wherein the network address switching method comprises:
receiving a registration request initiated by a phone, wherein the registration request is initiated by the phone based on a third public network address and a third port; the third public network address and the third port are generated by the phone by mapping a fourth public network address and a fourth port based on a connection status between the phone and a STUN server; and the phone obtains the fourth public network address of the STUN server by setting a field, and establishes a connection to the STUN server through the fourth port; and
respectively updating a public network address and a port of the phone to the third public network address and the third port based on the registration request, whereby a call center establishes a connection to the phone through the third public network address and the third port.

8. The adaptive network address switching method for VOIP according to claim 7, wherein the third public network address and the third port are generated by the phone by mapping a fourth public network address and a fourth port based on a connection status between the phone and a STUN server is specifically as follows:
enabling, if determining that the connection status between the phone and the STUN server indicates a successful connection, the phone to initiate a network binding request to the STUN server, whereby the STUN server outputs a mapped address and port of the phone in a public network based on the fourth public network address and the fourth port, and obtaining the third public network address and the third port through a router; or
obtaining, if determining that the connection status between the phone and the STUN server indicates a failed connection, the registration request initiated by the phone by an rport field, and obtaining the third public network address and the third port through the mapping based on the fourth public network address and the fourth port.

9. The adaptive network address switching method for VOIP according to claim 8, wherein the obtaining, if determining that the connection status between the phone and the STUN server indicates a failed connection, the registration request initiated by the phone by an rport field, and obtaining the third public network address and the third port through the mapping based on the fourth public network address and the fourth port is specifically as follows:
if determining that the connection status between the phone and the STUN server indicates the failed connection, obtaining a SIP registration request initiated by the phone by the rport field, making a Via header field carry the rport field, and outputting the third public network address and the third port that are obtained through the mapping based on the fourth public network address and the fourth port, wherein the third public network address and the third port are output by carrying a parameter related to the rport field in a success status response code.

10. The adaptive network address switching method for VOIP according to claim 7, wherein the third public network address and the third port are generated by the phone by mapping a fourth public network address and a fourth port based on a connection status between the phone and a STUN server further comprises:
if determining that the connection status between the phone and the STUN server indicates a successful connection, binding the STUN server and the third port by enabling the phone to send a TCP STUN Bind request to the STUN server; and
binding the STUN server and the third port again by enabling the phone to send TCP SIP signaling to the STUN server.

11. The adaptive network address switching method for VoIP according to claim 7, wherein the receiving a registration request initiated by a phone is specifically as follows:
receiving a SIP registration request initiated by the phone based on the third public network address and the third port, wherein the SIP registration request is constituted by the third public network address as a Contact header field of SIP registration signaling and the third port as a port of the SIP registration signaling.

12. The adaptive network address switching method for VOIP according to claim 7, wherein the phone obtains the fourth public network address of the STUN server by setting a field is specifically as follows:
setting, by the phone, a DHCP OPTION field in the STUN server, and using a router to obtain the fourth public network address of the STUN server.

13. An adaptive NAT apparatus for VOIP, applicable to a phone, wherein the NAT apparatus comprises: a first preprocessing module, an information obtaining module, and a first registration module, wherein
the first preprocessing module is configured to obtain a first public network address of a STUN server, and connect to the STUN server through a first port;
the information obtaining module is configured to obtain a second public network address and a second port based on a connection status with the STUN server, wherein the second public network address and the second port are generated by the STUN server or a registration server through mapping based on the first public network address and the first port; and
the first registration module is configured to initiate registration with the registration server based on the second public network address and the second port, whereby a public network address and a port of the phone in the registration server are respectively updated to the second public network address and the second port, and then a call center establishes a connection to the phone through the second public network address and the second port.

14. The adaptive NAT apparatus for VOIP according to claim 13, wherein the second public network address and the second port are generated by the STUN server or a registration server through mapping based on the first public network address and the first port is specifically as follows:
initiating, if determining that the connection status indicates a successful connection, a network binding request to the STUN server, whereby the STUN server outputs a mapped address and port of the phone in a public network based on the first public network address and the first port, and obtaining the second public network address and the second port through a router; or
initiating, if determining that the connection status indicates a failed connection, the registration with the registration server by an rport field, and obtaining the second public network address and the second port that are mapped by the registration server based on the first public network address and the first port.

15. The adaptive NAT apparatus for VOIP according to claim 14, wherein the initiating, if determining that the connection status indicates a failed connection, the registration with the registration server by an rport field, and obtaining the second public network address and the second port that are mapped by the registration server based on the first public network address and the first port is specifically as follows:
if determining that the connection status indicates the failed connection, initiating SIP registration with the registration server by the rport field, and making a Via header field of the registration server carry the rport field, whereby the registration server outputs the second public network address and the second port that are obtained through the mapping based on the first public network address and the first port, wherein the second public network address and the second port are output by the registration server by carrying a parameter related to the rport field in a success status response code.

16. The adaptive NAT apparatus for VOIP according to claim 13, wherein the obtaining a second public network address and a second port based on a connection status with the STUN server further comprises:
if determining that the connection status indicates a successful connection, binding the STUN server and the second port by sending a TCP STUN Bind request to the STUN server, and binding the STUN server and the second port again by sending TCP SIP signaling to the STUN server.

17. The adaptive NAT apparatus for VOIP according to claim 13, wherein the initiating registration with the registration server based on the second public network address and the second port, whereby a public network address and a port of the phone in the registration server are respectively updated to the second public network address and the second port is specifically as follows:
initiating SIP registration with the registration server by the second public network address as a Contact header field of SIP registration signaling and the second port as a port of the SIP registration signaling, whereby the public network address and the port of the phone in the registration server are respectively updated to the second public network address and the second port.

18. The adaptive NAT apparatus for VOIP according to claim 13, wherein the obtaining a first public network address of a STUN server is specifically as follows:
setting a DHCP OPTION field in the STUN server, and using a router to obtain the first public network address of the STUN server.
